(19) United States
(12) Patent Application Publication
(10) Pub. No.: US 2010/0300239 A1
(43) Pub. Date: Dec. 2, 2010

(54) COUPLING MEANS, IN PARTICULAR FOR A FURNITURE ADJUSTMENT MEANS

(76) Inventor: Josef RUTZ, Rosenheim (DE)

Correspondence Address: NIXON & VANDERHYE, PC, 901 NORTH GLEBE ROAD, 11TH FLOOR, ARLINGTON, VA, 22203, US

(21) Appl. No.: 12/777,547

(22) Filed: May 11, 2010

(30) Foreign Application Priority Data
May 27, 2009 (EP) 09 007 082.2-1258

(51) Int. Cl. A47B 3/00; F16C 1/12; A47B 13/08

(52) U.S. Cl. 74/501.6

(57) ABSTRACT

An improved coupling means, in particular for adjustable pieces of furniture, is distinguished by the following features:
the coupling means (51) comprises a transmission and coupling means (67, 167),
the transmission and coupling means (67, 167) is constructed in such a way that the at least one secondary transmission means (133; 133a, 133b) is always adjusted whether one primary transmission means (131; 131a, 131b) is actuated or whether the other primary transmission means (131; 131a, 131b) is actuated, and
at least two catch decoupling means (155; 155a; 155b) are provided in such a way that when the at least one primary transmission means (131; 131a or 131b) is adjusted, disengaged by an adjustment of the associated actuation means (15; 15a, 15b), the transmission and coupling means (67, 167) is always also entrained and adjusted, while the second catch decoupling means (155b) cooperates with the transmission and coupling means (67, 167) in such a way that the adjusting or pivoting transmission and coupling means (67, 167) leaves this second secondary transmission means (133; 133b or 133a) and/or the second actuation means (15; 15b or 15a) unchanged in position.

The invention relates to a coupling means, in particular for a furniture adjustment means according to the preamble of claim 1.

An adjustable piece of furniture is known from EP 0 572 770 B1 and EP 1 159 887 B1, for example. Each of these two prior publications discloses a folding table, comprising T-shaped bases which are arranged at the end face and support a work surface or table top. This table top is conventionally oriented horizontally in a work and use position.

This work surface or table top can be pivoted between the conventional, approximately horizontally oriented work and use position and an approximately vertical storage position.

A locking mechanism is therefore provided as an adjustment means and fixes the work surface in the conventional, approximately horizontal use position thereof. By contrast, if the work surface is to be pivoted into a space-saving storage position, the locking mechanism is actuated in such a way that said surface can be pivoted about a horizontal pivot axis into the approximately horizontal storage position thereof.

The locking mechanism can for example be disengaged using an actuation means, which is arranged of the underside of the table top directly alongside the longitudinal edge. If the table top is for example to be pivotable about a horizontal pivot axis in both directions, in such a way that the table top can be pivoted into the storage position thereof at any time independent of from which side a user approaches the table, it is expedient to provide an actuation and disengagement means, with which the locking mechanism can be released, alongside each of the two longitudinal sides of the table top on the underside.

The object of the invention is to provide an improved adjustment means, in particular for an adjustable piece of furniture.

The object is achieved according to the invention by a coupling means having the features specified in claim 1. Advantageous embodiments of the invention are specified in the subclaims.

In the context of the invention, a coupling means for adjusting pieces of furniture or furniture parts, in particular a locking and release means for pivotable table tops is provided, and may comprise a plurality of actuation means, for example two actuation means. In particular for a pivotable table top, at least one actuation means for unlocking the table top is provided on the underside of the table top along each longitudinal side of the table top, and can only be pulled into the disengagement and released position against the force of a spring means for example. Thus, the locking means is finally adjusted into the released position, in such a way that the table top can be pivoted for example from the conventional, generally horizontal use position thereof into an approximately vertical storage position.

However, in the context of the invention a coupling means is now provided between the at least two actuation means and the locking means, and ensures that when an actuation and disengagement means is actuated, the further actuation or disengagement means provided in each case on the opposite table top underside alongside the longitudinal edge is not also moved or adjusted.

For this purpose, in the context of the invention the coupling means is constructed in such a way that when only one actuation means out of at least two provided actuation means is adjusted, only the adjustment brought about by this one actuation means is ever passed on via the coupling means according to the invention to the at least one or preferably two furniture adjustment means, preferably in the form of a locking and release means, the second actuation means which is not adjusted remaining in the starting position thereof, in effect being decoupled.

According to the invention, this can be provided in that when one of the two actuation means is actuated via the so-called primary transmission means which is thus adjusted, the coupling means is acted on in such a way that the secondary transmission means, leading from the coupling means to the at least one furniture adjustment means, is also adjusted and thus the other primary transmission means, proceeding from the other, non-adjusted actuation means and leading to the coupling means, remains unadjusted.

This concept can be provided by various measures within the scope of the invention.

In a preferred embodiment of the invention, this is achieved by two slides, which are coupled to one another by a transmission and coupling means which acts between them. If an actuation and disengagement means is actuated, this causes one slide to be adjusted against the force of a spring means, for example in the longitudinal direction, and causes the secondary transmission means, which engages on said slide for example and is connected to the adjustment or locking means of the table for example, also to be adjusted. The opposite, second slide is also adjusted via the coupling means, and comprises for example a catch decoupling means having a sufficiently long release path that ultimately the second primary transmission means (which thus leads to the second actuation means) is not also adjusted but remains in the starting position thereof without any change.

The invention is explained in greater detail in the following by way of embodiments, in which, specifically:

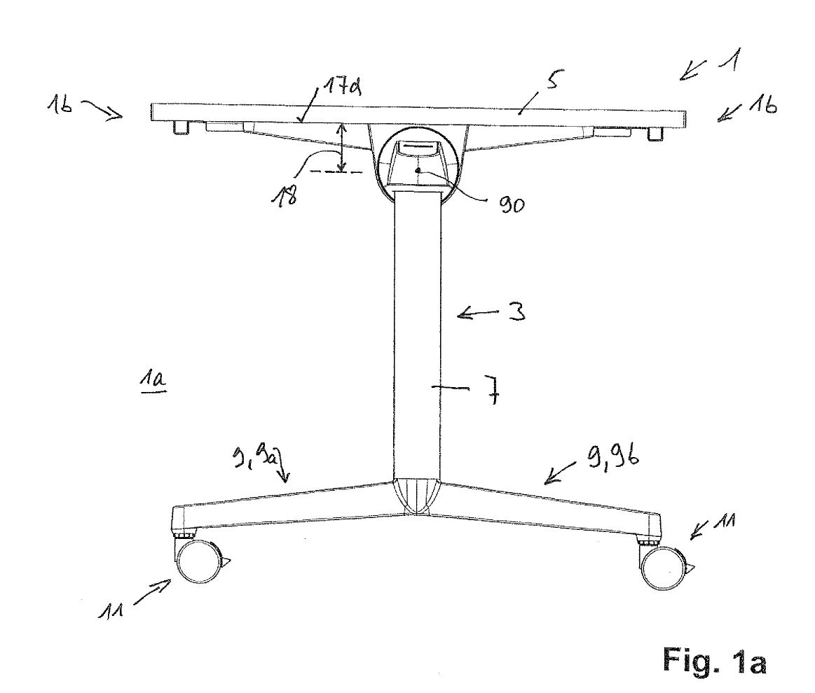

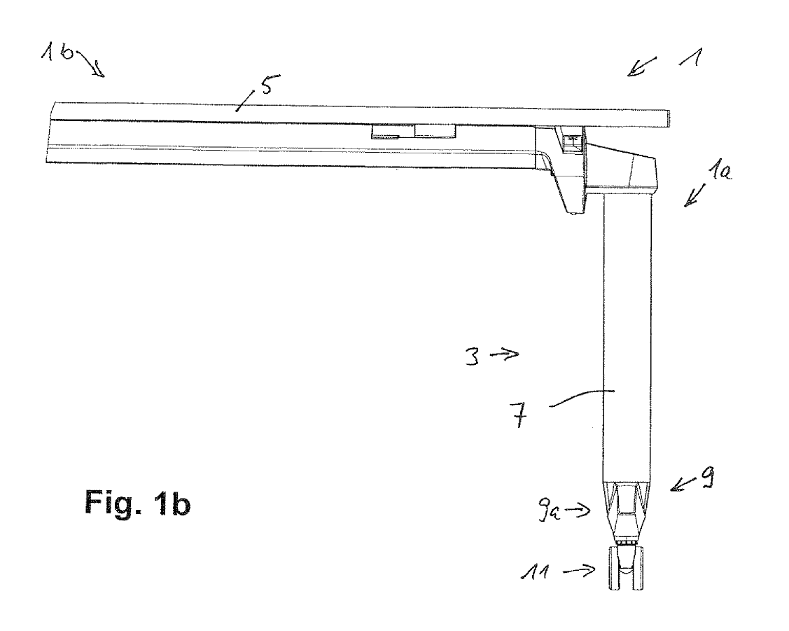

FIG. 1a is an end view of a folding table according to the invention;

FIG. 1b is a longitudinal side view of a detail of the folding table according to the invention, with the support column arrangement arranged at the right-hand end of the table;

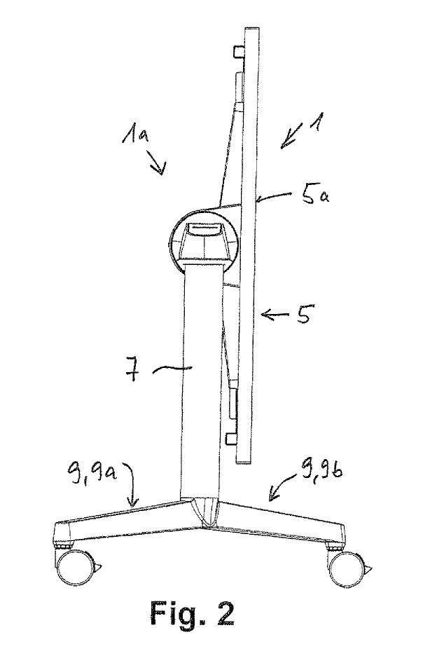

FIG. 2 is an end view, comparable to FIG. 1, of the table according to the invention, in which the table top has been pivoted to the right into the storage position thereof;

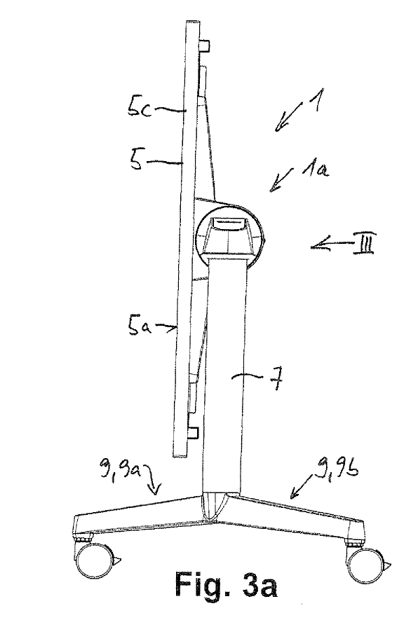

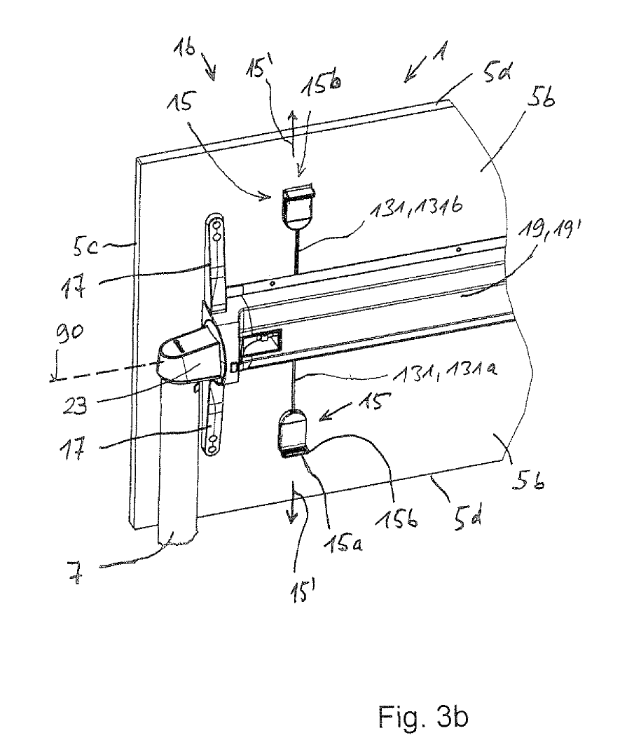

FIG. 3a is an end view comparable to FIG. 3a, but in which the table top is pivoted into the opposite storage position;

FIG. 3b is a rear view of part of the folding table shown in FIG. 3a with the work surface folded into the storage position;

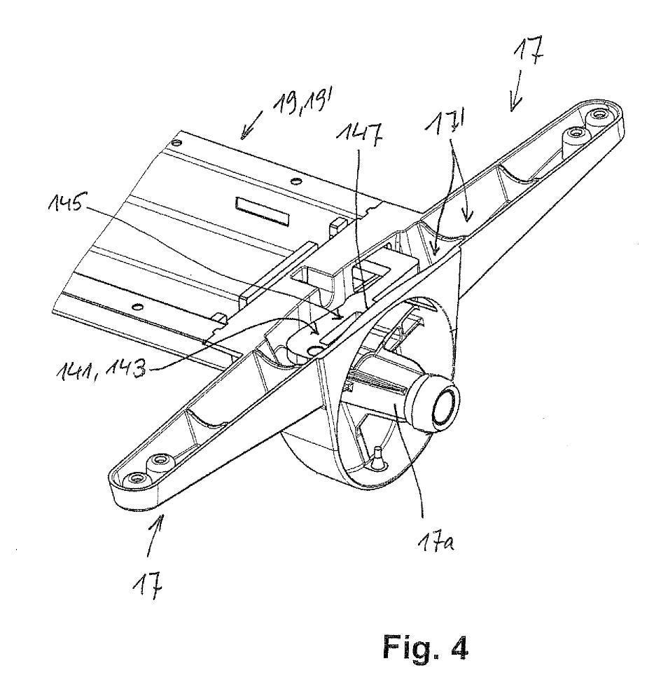

FIG. 4 is a three-dimensional view of a detail of a two-armed table top support having an associated hollow shaft and a mounted bevel gear fixed in rotation therewith, adjacent to a cable channel;

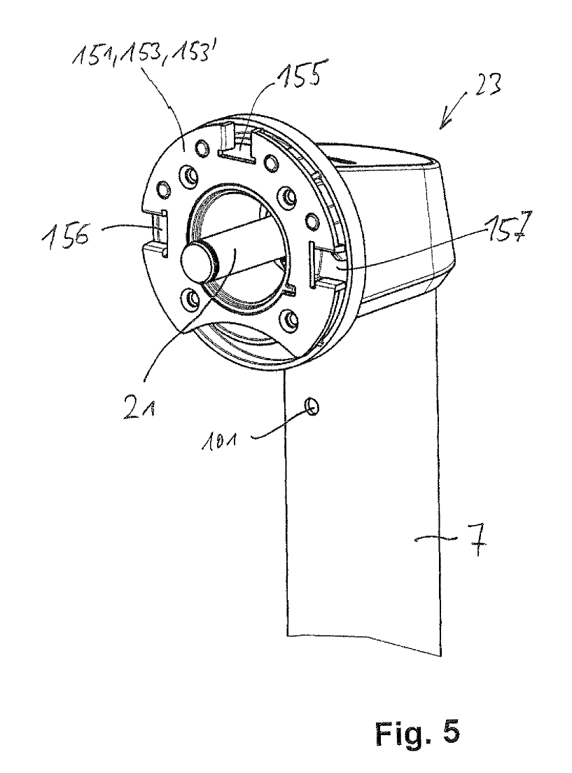

FIG. 5 is a three-dimensional schematic view of a bracing and supporting head with associated ratchet wheel and fixed axle;

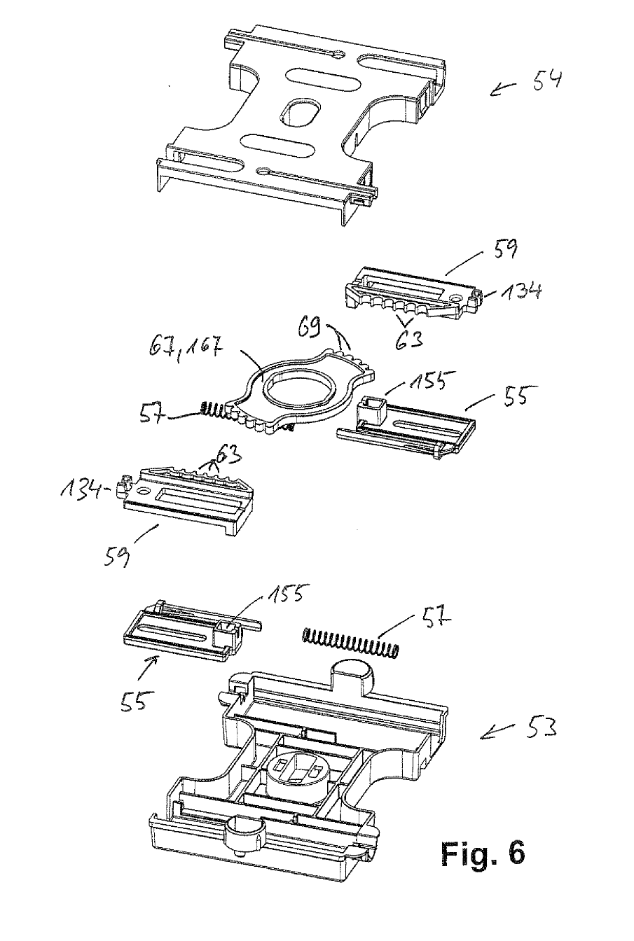

FIG. 6 is an exploded view of all of the relevant parts of the coupling means according to the invention;

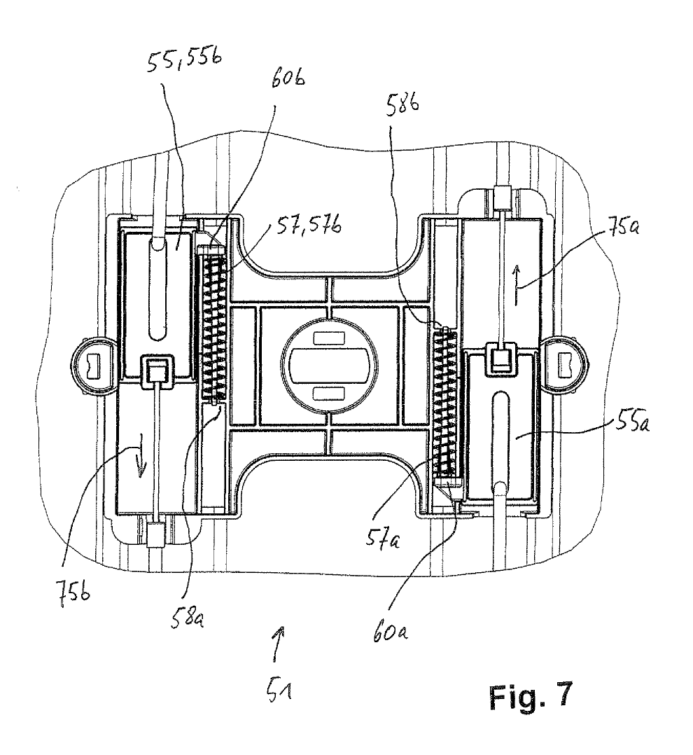

FIG. 7 is an enlarged detail of the coupling means according to the invention, omitting the coupling housing lid and other components:

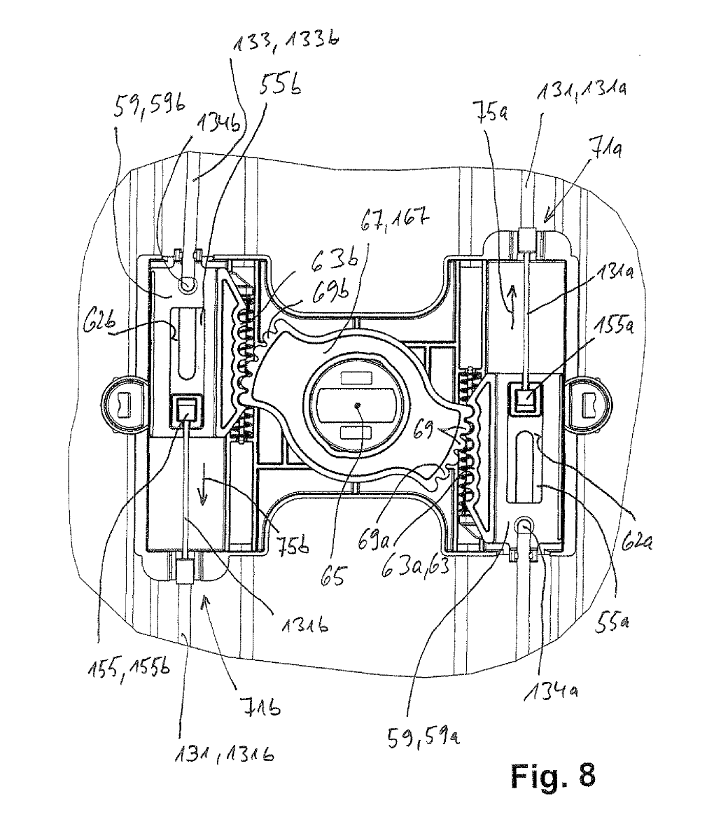

FIG. 8 is a view corresponding to FIG. 7, in which further components associated with the coupling means are also incorporated, such as two parallel slides and a coupling transmission means;

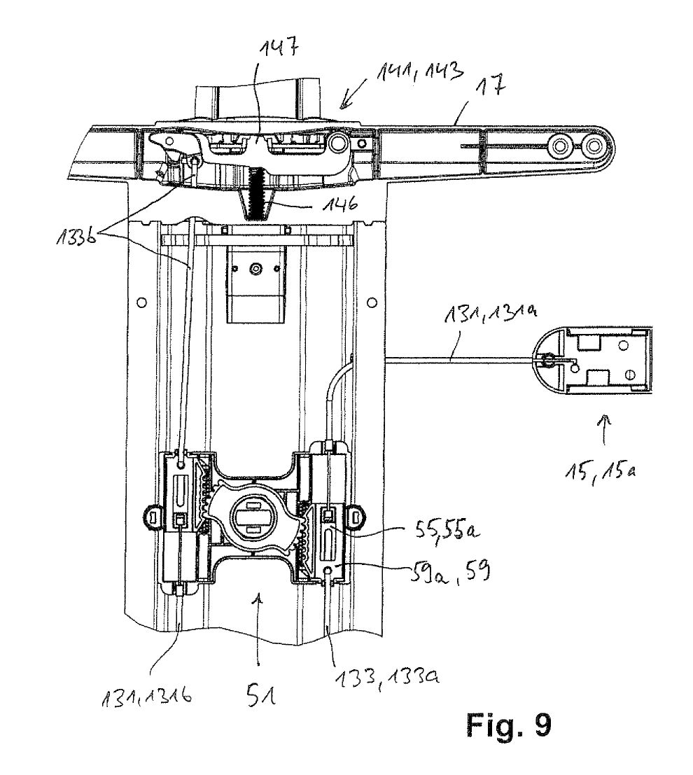

FIG. 9 is a detail of the coupling means according to the invention and an actuation member attached to said coupling means as well as a locking and release means, in the basic, starting position, which is actuated via the coupling means;

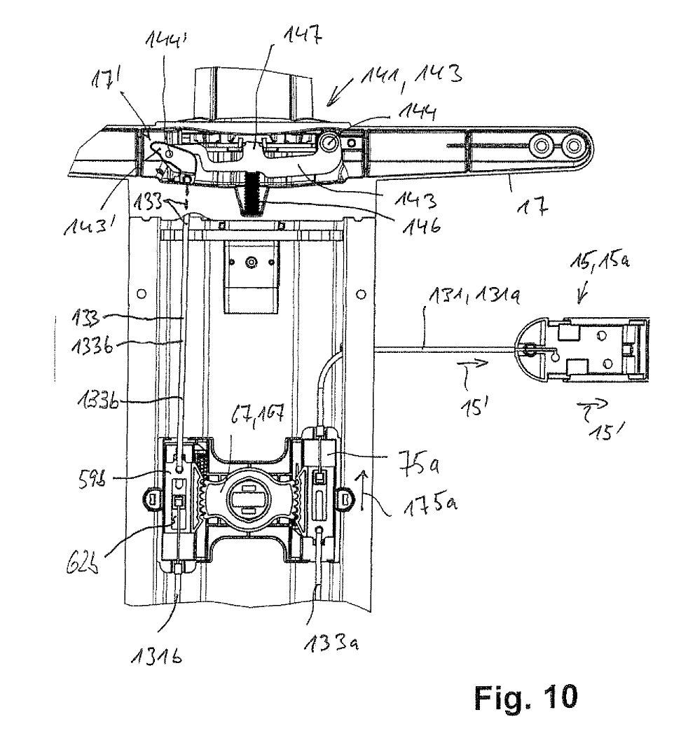

FIG. 10 is a view corresponding to FIG. 9, in which the coupling means is located in an intermediate position;

FIG. 11 is another further view corresponding to FIGS. 9 and 10, but with the coupling means fully pivoted in an end position opposite the starting position, with the locking means released;

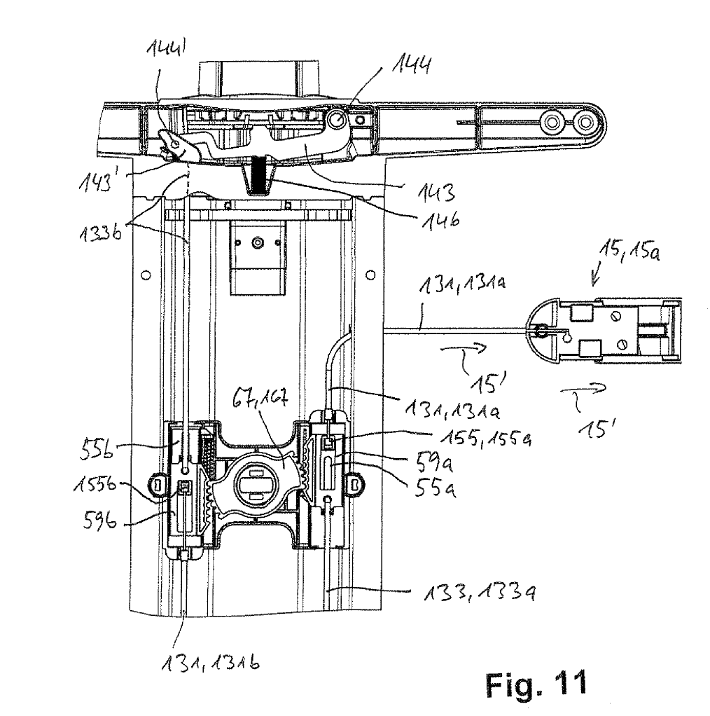

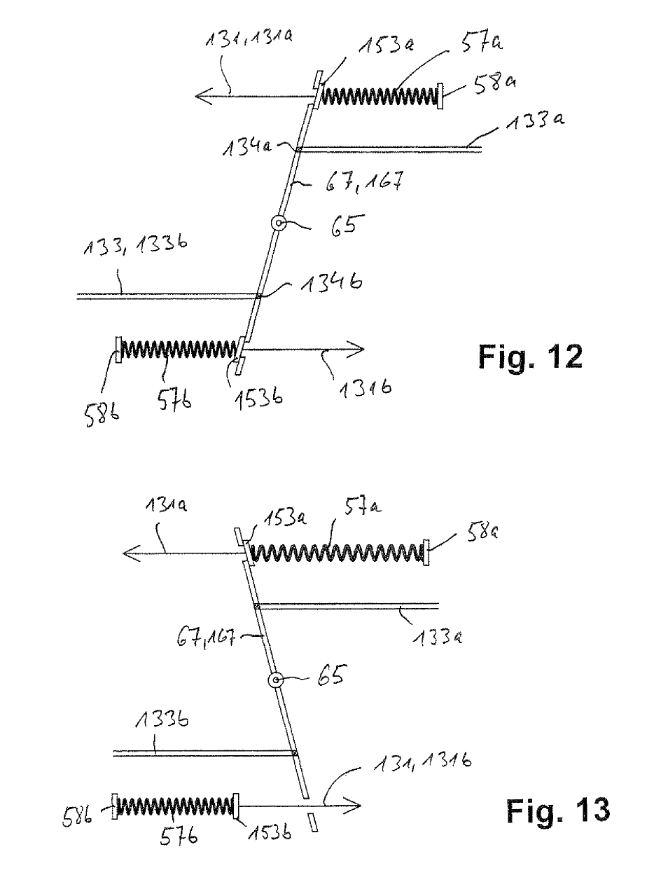

FIG. 12 is a schematic view of a further basic example of a configuration according to the invention of a coupling means according to the invention in the basic, starting position thereof; and

FIG. 13 is a view corresponding to FIG. 12 with the coupling means adjusted into the two end positions.

FIG. 1a shows for example the right-hand end face 1a of a folding table 1. FIG. 1b is the right-hand part of one longitudinal side 1b of the table 1, showing the support means 3 which is arranged on the right in this view.

It can be seen from the drawings that the folding table 1 comprises an upwards-facing table top 5, which in FIGS. 1a and 1b is located in the generally horizontally oriented work position thereof.

The support means 3 is provided at each of the two opposite end faces 1a and in the embodiment shown comprises a respective support column 7, which transitions downwards into a support base 9, which comprises support base portions 9a and 9b projecting on either side of the support column 7.

A roller arrangement 11 is provided on each of the opposite ends of the support bases 9 and is conventionally provided with a fixing or releasing mechanism. This means that the folding table can be moved for various uses or storage positions without difficulty. In each desired work position it can be ensured, by actuating the locking mechanism integrated into the rollers, that the table is not moved accidentally.

FIG. 2 reproduces the right-hand end face 1a of the table as shown in FIG. 1, with the table top brought into the vertically extending storage position arranged on the right.

In FIG. 3a, by contrast with FIG. 2, the table top 5 has been brought into the opposite pivot position, and FIG. 3b is a rear view, in the direction of the arrow III shown in FIG. 3a, of part of the underside 5b of the table top 5 when folded into the storage position.

So that the work surface can be folded into the storage position around a horizontal pivot axis 90 (FIG. 3b) from either longitudinal side 1b of the folding table 1, a disengagement and/or actuation mechanism 15 is provided on the two opposite longitudinal sides 1a of the folding table on the underside 5b of the table top 5 (FIG. 3b). If this disengagement and/or actuation mechanism 15 is for example pulled in the direction of the arrow 15′ towards the adjacent longitudinal edge 5d of the table top 5 (specifically by gripping an associated handle portion on the actuation means 15), this releases a locking mechanism (described in greater detail below) in such a way that a table top located in the work position can then be folded into the storage position, pivoted through 90°, thereof or vice versa. It can be seen from FIG. 3b that for example two actuation means 15a and 15b are provided, one actuation means being arranged alongside one longitudinal edge 5d and the other actuation means being arranged alongside the opposite longitudinal edge 5d on the underside of the table top, in such a way that it is possible from either side to grip a corresponding actuation means 15 and thus to carry out the desired adjustment.

As can be seen from the drawings, a two-armed table top support 17, extending parallel to the end face 5c of the table top 5 in the embodiment shown, is provided offset inwardly on the underside 5b of the table top 5, in each case in the end face region of the end face 5c of the table top 5, and is screwed onto the underside 5b of the table top 5 using screws for example.

A trough 19 is fixed to the underside of the table top, between the two two-armed table top supports 17 arranged alongside the end edges 5c of the table top 5, and acts as a cable channel 19′.

The two-armed table top support 17 transitions—as can be seen in particular from the three-dimensional detail according to FIG. 4—into a hollow shaft 17a, which lies at a predetermined distance 18 below the upwards-facing construction plane 17d (FIG. 1a) of the two-armed table top support 17, the underside of the table top 5 being laid on said plane and fixed to the table top support. The aforementioned distance 18 between the underside of the table top 5 and the horizontal pivot or tilt axis 90 (FIG. 3b) extending centrally through the hollow shaft 17a is of a sufficient size to travel past the respective stand means in the form of support columns, i.e. past the support columns 7, when the table top 5 is pivoted into one of the two opposed storage positions (in which the table top is suspended oriented more or less vertically).

An axle 21 (FIG. 5) engages in this hollow shaft 17a and is braced rigidly in a bracing head 23, which is in turn supported directly on the upper end of the support column 7.

This provides the possibility of the two-armed table top support 17 being pivoted together with the table top 5, in each case around the non-rotating axle member 21 from the upwards-facing, approximately horizontal work position into one of the two mutually opposed storage positions, in which the work surface is oriented more or less in the vertical direction.

The table top is to be locked, at least in the single work position thereof, conventionally in the horizontal position, by a locking mechanism mentioned above, in such a way that pivoting is reliably prevented.

For this purpose, the locking mechanism comprises a furniture adjustment means 141, in the present embodiment specifically in the form of a locking and release means 143, which comprises on the one hand a pivotable locking and/or retaining means 151 having a catch pin 147, and on the other hand a catch means 153, which is formed as a locking disc 153′ in the present embodiment.

As can be seen from FIG. 5, the locking disc 153′ comprises three catch recesses 155, 156 and 157, mutually offset in the circumferential direction, the first catch recess 155 being arranged in the vertically upwards-facing position and the catch recesses 156, 157 being arranged in the horizontal position, diametrically opposite relative to the horizontally oriented axle 21.

In the embodiment shown, the locking disc 153′ is preferably screwed onto the bracing and retaining head 23 and thus held fixed axially and above all radially. The aforementioned recesses 155, 156, 157 which are offset in the circumferential direction may, depending on the catch position, be penetrated by an axial catch pin 147 (FIG. 4), which is part of the actuation means 141 or is positioned thereon. The actuation means 141 having the locking and release means 143 and having the catch pin 147 which is formed or positioned thereon may for example be held in a recess 17′ of the two-armed table top support 17 so as to be displaceable and pivotable.

The following figures schematically show a coupling means 51 according to the invention for adjustable parts of pieces of furniture, for example for actuating a locking and release means 143 on a table with a pivotable table top 5.

Thus, FIG. 6 is a perspective, exploded view of an arrangement of the coupling means, together with an adjustment housing 53, an adjustment housing lid 54, and various adjustable components installed inside the housing.

FIGS. 7 to 9 follow, and show the basic construction, further to the exploded view of FIG. 6.

It can be seen from the drawings that the coupling means 51 in the embodiment shown comprises two adjustment slides 55, i.e. 55a and 55b, arranged mutually transversely offset and oriented mutually parallel, in the adjustment housing 53 shown in part (shown when open) in FIG. 7.

Each adjustment slide 55 is held biased, by a spring means 57, into the single basic, starting position thereof, which it adopts when an actuation means 15 is not pulled out. Each spring means 57a or 57b is supported on the one hand against a stop 58a or 58b which is fixed to the housing and on the other hand against a stop 60a or 60b which moves together with the respective adjustment slide 55, and is therefore biased towards compression.

As can be seen by comparing FIG. 7 and FIG. 8, a parallel slide 59 is provided in the region of each adjustment slide 55a, 55b, and comprises a longitudinal recess 62a or 62b, a catch decoupling means 155a engaging in or penetrating through said recess, this catch decoupling means 155a in each case being formed on or fixed to the associated adjustment slide 55a or 55b. In the embodiment shown, this catch decoupling means 155a or 155b is of a square shape in a plan view.

Each parallel slide 59a or 59b is guided by longitudinal displacement in the corresponding housing recess of the adjustment housing 53 and/or on the associated adjustment slide 55, specifically taking into account the following particulars.

Each of the two parallel slides 59 is provided on the side facing the other with a toothed extension 63, i.e. with ribs 63, a transmission member 67 being arranged in the middle so as to be rotatable about a central axis 65 and also being equipped externally over part of the circumference thereof with a toothed extension 69, one toothed extension 69a engaging, i.e. interlocking, with one toothed extension 63a on one parallel slide 59a, and the other toothed extension 69b on the transmission member 67 engaging, i.e. interlocking, with the other toothed extension 63b on the other parallel slide 59b.

As was shown previously in FIG. 3b, a first and a second actuation means 15a and 15b are provided, and are each connected to the coupling means 51 via a primary transmission means 131, for example in the form of a Bowden cable (or another suitable means). In other words, one actuation means 15a is connected via one primary transmission means 131a and the second actuation means 15b is connected via the second primary transmission means 131b to two different points on the coupling means.

It can thus be seen from the plan view of FIGS. 7 and 8 that the primary transmission means 131a coming from the first actuation member 15a and leading to one adjustment slide 55a leads via the associated entrance face 71a on the adjustment housing 51 to this one adjustment slide 55a and is rigidly braced to a bracing point 155a located there. The second actuation means 15b is connected to the second adjustment slide 55b via the second transmission means 131b coming through the second entrance face 71b, specifically at a second bracing point 155b, these bracing points 155 forming the so-called catch decoupling means 155 in the embodiment shown.

As can be seen from the remaining FIGS. 9, 10 and 11, the coupling means 51, i.e. the parallel slides 55a and 55b, are connected via a further, i.e. secondary transmission means 133 to an associated furniture adjustment means 141, in the form of a locking and release means 143 in the embodiment shown. Thus, the remaining FIGS. 9, 10 and 11 show the coupling means 51, at least together with one actuation means 15a and the associated primary transmission means 131a, the second primary transmission means 131b coming from the second actuation means 15b only being shown in part. The associated secondary transmission means 133a and 133b now engage on the aforementioned, mutually opposed faces of the associated parallel slides 59a, 59b, and lead both to the locking and release means 143 leading along one end face of the adjustable table and to a second locking and release means 143 provided on the opposite end face of the table having the adjustable table top (FIGS. 9 to 11 only showing or indicating the locking and release means 143 provided on one end face).

In other words, the secondary transmission means 133a and 133b are fixed to the relevant associated parallel slide 59a or 59b at fixing points 134a and 134b.

The operation will be discussed in greater detail in the following.

If for example one actuation means 15a on the underside of the table top alongside the respective longitudinal side 5d is pulled in the direction of the arrow 15′, then the associated transmission means 131a (in this case in the form of a Bowden cable, although it is of course also possible for a different force transmission and adjustment means to be provided) is also pulled out, in such a way that the associated adjustment slide 55a is adjusted against the force of the spring means 57, 57a towards the opposite adjustment position thereof in the adjustment housing 53, i.e. on the adjustment path 75a thereof in the direction of the arrow 175a (FIG. 10). Because the catch 155a, which penetrates through the aforementioned longitudinal recess 62a in the parallel slide 59a, is formed on the adjustment slide (the catch 155a simultaneously representing the bracing position 56a for the first actuation and disengagement means 131a), the parallel slide 59a is thus also adjusted via the adjustment slide 55a from the starting position thereof shown in FIG. 9 through the intermediate position thereof shown in FIG. 10 into the end position thereof shown in FIG. 11. The parallel slide is also entrained because the catch 155a penetrates through the longitudinal recess 62a at the end of said longitudinal recess 62a and, when tensioned via the aforementioned actuation and disengagement means 131a, is supported directly against the delimiting stop of the longitudinal recess 60a and thus also adjusts the parallel slide 59a.

Because the adjustment and transmission means 133a, which leads to one locking and release means 143 on one end face of the table, engages on the opposite end of the parallel slide 59, it accordingly adjusts a locking mechanism (for example a locking lever described further below) from the locked position into the released position thereof.

However, it can also be seen from FIGS. 9 and 10 that the adjustment (i.e. displacement) of the parallel slide 59a, via the toothed extensions 63 formed internally thereon, also rotates the transmission means 67 which on the opposite side thereof is in engagement with the further parallel slide 59b via the toothed engagement which is present there. In this way, the second parallel slide 59b located on the opposite side is also adjusted into the opposite position, by contrast with FIG. 6, on the adjustment path 75b thereof. Because the second secondary transmission means 133b, which leads to the second release and locking means 143 (which is provided on the end face, shown in FIGS. 9 to 11, of the table for unlocking and pivoting the table top), also engages on one end of this parallel slide 59b which is also adjusted, the two locking and release means 143 provided on the two opposite end faces of the table are only pivoted into the released position by pulling on an actuation member 15a.

However, in this operation, despite the adjustment of the second parallel slide 59b, this second adjustment slide 55b has been held undisplaced because of the force of the spring means 57b acting on it. This is also because the slit 62b in the second parallel slide 59b is sufficiently long that the catch decoupling means 155b projecting through this slit 59b can dip into this slit without interacting with the delimitations at the ends of the slit and remain undisplaced in the starting position thereof. Thus, the primary transmission means 131b which is connected to the second actuation means 15b via the second adjustment slide 55b, and thus the associated actuation means 15, 15b are also not adjusted.

If the aforementioned first actuation means 15a is released again, then for example the spring means 57a, which presses against the first adjustment slide 55a (for example also via a further spring means 146, described further below, provided in the respective locking means), is displaced back into the starting position thereof shown in FIG. 9. Thus, the transmission means 67 is also pivoted back and the second parallel slide 59b is also guided back into the starting position thereof without the adjustment slide 55b moving.

If for example the second actuation means 15b were then actuated, starting as in FIG. 9, the parallel slide 59b on the left in FIG. 9, and via the catch 155b also the parallel slide 59b, would thus be adjusted into the opposite adjustment position. In this way, the second secondary transmission means 133b is also pulled out directly and the locking and release means 143 connected thereby is adjusted into the released position. However, the first parallel slide 59a is also adjusted (now without the first adjustment slide 55a moving) into the pulled-out position thereof via the aforementioned transmission means 67 and the toothed engagement with the first parallel slide 59a, also pulling out the secondary transmission means 133a which is connected to this parallel slide and which leads to the first locking and release means 143 and adjusts said means into the released position.

The advantage of this arrangement is thus still that when an actuation means is pulled out, the respective other actuation means 15 is always decoupled, i.e. not automatically also adjusted.

If, for example, only a single actuation means for furniture, for example only one locking and release means 143, is provided, then only one adjustment transmission means 133 is positioned on the aforementioned adjustment means 51 and is for example connected either to the first parallel slide 59a or to the second parallel slide 59b.

In the following, for completeness, one of a number of possible locking and release means 143 will be described briefly by way of the drawings.

As can be seen from FIGS. 9 to 11, the locking and release means 143 comprises for example a locking lever 143′, which is pivotable about an axis 144 and comprises a locking pin 147, which latches into a fixed latch recess 55, for example 55a (FIG. 5), and is in particular acted on by the force of the aforementioned spring means 146.

In the embodiment shown a lever transmission is also provided, i.e. a second locking lever 143′ of smaller dimensions is articulated about a further pivot axis 144′ in the region of the free end of the first locking lever 144, the aforementioned adjustment and transmission means 133 then being positioned on this second locking lever 143′ and being connected to a respective associated first or second parallel slide 59a, 59b. If, as mentioned above, the adjustment means 51 is accordingly adjusted by actuating an actuation means, then the two aforementioned adjustment transmission means 133a, 133b are pulled out and thereby the associated catch pins 147 are slid out from the respective catch recesses 55 by the two locking levers, in such a way that the table top support 17 is then freely pivotable together with the associated table top 5 about a horizontal axis 90, for example into the approximately vertically oriented storage position thereof. If the actuation means is released again, then the respective catch pin is slid back into a catch recess 55 by the spring means 57 in the adjustment means 51 and also by the additional spring means 146 on the locking and release means 143, if located in the direct extension of this catch pin 147 when the table top is correspondingly extended (in the horizontal or for example vertical direction).

A further, simplified principle for an adjustment means according to the invention is discussed by way of FIGS. 12 and 13.

From the basic drawing of FIG. 12, it can be seen that in this case too a transmission means 67 is provided for example in the form of a transmission means 67 pivotable about a central axis 65, and said means will also sometimes be referred to as a coupling means 167 in the following. One of the two adjustment and transmission means 133a and 133b of this coupling means 167 which lead to the respective locking and release means 143 is in each case positioned on one of two opposite points, offset relative to the central axis 65.

If for example the transmission means 131a shown at the top, leading to one actuation means 15a, is now pulled, then the transmission and coupling means 67, 167 in the form of a double lever is also rotated anticlockwise from the position shown in FIG. 12 into the position shown in FIG. 13 by the catch 153a, in this way, the two secondary transmission means 133a and 133b leading to the locking and release means 143 are also entrained and pulled out, since these adjustment and transmission means are rigidly connected to the transmission and coupling means 67, 167 at the fixing points 134a and 134b.

It is thus preferred in each case for a relevant catch 155 or the relevant transmission means 131 also to be acted on by the force of one of the aforementioned spring means 57a and 57b (specifically, in the tension or compression direction depending on the support point, the spring means being biased under tension in the assignment according to FIGS. 12 and 13), in such a way that when the actuation means 15 is released, this spring means pivots the entire adjustment means 51 back into the basic position thereof shown in FIG. 12.

However, for the adjustment process described, triggered by the actuated actuation means 15a, it can be seen in the drawings, in the transition from FIG. 12 to FIG. 13, that although the catch 153a (which is pulled out by the actuation means 15a) does pivot in correspondence with the transmission and coupling means 67, 167, the opposite catch 153b simultaneously remains held in the starting position thereof by the spring means 57b thereof, since the opposite catch 153b is simultaneously decoupled from the rotated transmission and coupling means 67, 167. In other words, the construction is of a type such that although the transmission and coupling means 67, 167 is rotated anticlockwise when the respective transmission means 131a, 131b is adjusted, rotation of the coupling means 67, 167 nevertheless retains the catch 155, which is connected to the non-actuated transmission means 131a or 131b, in an undisplaced manner in its shown starting position and in this way the respective second transmission means 131, which is not acted on, and thus the associated second actuation means 15 remain in the starting position thereof.

In other words, FIGS. 12 and 13 only show in a simplified manner that with tensile loading an entrainment effect is present to the extent that the force introduced via the actuation and disengagement means leads to pivoting of the coupling means and thus of the transmission means 67, 167, but that this pivoting movement retains the non-actuated, non-adjusted transmission means 131 in an unpivoted manner in the starting position thereof because of the spring effect present thereon.

Further modifications are possible in this context.

In this embodiment too, if only one locking and release means 143 is disengaged, then only one of the two secondary transmission means 133a or 133b is omitted.

1. Coupling means for a furniture adjustment means (141), in particular for a table top (5), which can be pivoted, locked and released via a locking and release means (143), of a table, having the following features:
at least two actuation means (15; 15a, 15b) are provided, via which at least one furniture adjustment means (141) can be actuated indirectly,
the at least two actuation means (15; 15a, 15b) are each connected, via a primary transmission means (131; 131a, 131b) associated therewith, to the coupling means (51),
the coupling means (51) is connected via at least one secondary transmission means (133; 133a, 133b) to the at least one furniture adjustment means (141),
when at least one of the two actuation means (15; 15a, 15b) is actuated, the coupling means (51) can be adjusted via the associated primary transmission means (131; 131a, 131b) in such a way as to adjust the at least one secondary transmission means (133; 133a, 133b) and thereby the furniture adjustment means (141), characterised by the following further features:
the coupling means (51) comprises a transmission and coupling means (67, 167),
the transmission and coupling means (67, 167) is constructed in such a way that the at least one secondary transmission means (133; 133a, 133b) is always adjusted whether one primary transmission means (131; 131a, 131b) is actuated or whether the other primary transmission means (131; 131a, 131b) is actuated, and
at least two catch decoupling means (155; 155a; 155b) are provided in such a way that when the at least one primary transmission means (131; 131a or 131b) is adjusted, disengaged by an adjustment of the associated actuation means (15; 15a, 15b), the transmission and coupling means (67, 167) is always also entrained and adjusted, while the second catch decoupling means (155b) cooperates with the transmission and coupling means (67, 167) in such a way that the adjusting or pivoting transmission and coupling means (67, 167) leaves this second secondary transmission means (133; 133b or 133a) and/or the second actuation means (15; 15b or 15a) unchanged in position.

2. Adjustment means according to claim 1, characterised in that one or two secondary transmission means (133; 133a, 133b) are positioned directly or indirectly on the transmission and coupling means (67, 167) and lead to one or two furniture actuation means

3. Adjustment means according to claim 1, characterised in that the transmission and coupling means (67, 167) consists of a transmission and coupling means (67, 167) in the form of a double lever, which is adjustable about a central axis (65), a secondary transmission means (133; 133a or 133b) being positioned offset from the central axis (65) on one side of the transmission and coupling means (67, 167) and further secondary transmission means (133; 133b or 133a) optionally being positioned on the opposite side of the central axis (65), this means or these means leading to an associated furniture actuation means (141).

4. Adjustment means according to claim 1, characterised in that the coupling means (51) comprises two parallel slides (69) which are diametrically opposed about the central axis (65) and which are adjustable on an adjustment path (75a, 75b), one secondary transmission means (133; 133a or 133b) being positioned on one parallel slide (69) and the optionally provided second secondary transmission means (133; 133b or 133a) being positioned on the other parallel slide (59b).

5. Adjustment means according to claim 4, characterised in that on each of the two adjustment paths (75a, 75b), an adjustment slide (55; 55a, 55b) is adjustable along the adjustment path (75a, 75b) against the force of a spring means (57; 57a, 57b) and is provided with a catch decoupling means (155; 155a, 155b) in such a way that an adjustment of the adjustment slide (55; 55a, 55b) also adjusts the coupled parallel slide (59; 59a, 59b) via the catch decoupling means (155;155Sa, 155b).

6. Adjustment means according to claim 5, characterised in that the catch decoupling means (155; 155a, 155b) are constructed in such a way that if only one actuation means (15; 15a, 15b) is actuated, causing adjustment of the associated adjustment and parallel slide (55, 55a, 55b; 59, 59a, 59b) and thereby causing adjustment of the transmission and coupling means (67, 167), then the second parallel slide (59; 59b, 59a) is also adjusted, whilst the adjustment slide (55; 55b, SSa) cooperating with this parallel slide (59; 59b, 59a) is held by the spring means (57; 57b, 57a) so as to remain in the starting position thereof.

7. Adjustment means according to claim 1, characterised in that the parallel slides (59; 59a, 59b) are provided on the mutually facing inner faces thereof with a toothed extension or ribs (69), which interlock with corresponding teeth or ribs (69; 69a, 69b) on the outer circumference of the transmission and coupling means (67, 167).

8. Adjustment means according to claim 1, characterised in that in each adjustment slide (55; 55a, 55b) a catch decoupling means (155; 155a, 155b) penetrates or dips into a slit (62; 62a, 62b) and in doing so is positioned in such a way that the catch decoupling means (155; 155a, 155b) entrains the associated parallel slide (59; 59a, 59b) during adjustment movement disengaged via the actuation means (15; 15a, 15b), whilst an adjustment movement, introduced by the transmission and coupling means (67, 167), of the parallel slide (59; 59a, 59b) merely adjusts the parallel slide (59; 59a, 59b) relative to the adjustment slide (55; 55a, 55b), while the catch decoupling means (155; 155a, 155b) dipping into the slit (60; 60a, 60b) remains unadjusted.

9. Adjustment means according to claim 1, characterised in that the at least one adjustment and transmission means (67, 167) is positioned directly on the transmission and coupling means and is rigidly connected thereto.

10. Adjustment means according to claim 1, characterised in that the catch decoupling means (155; 155a or 155b) engages on the transmission and coupling means (67, 167) on the side opposite the associated primary transmission means (131; 131a, 131b) in the disengagement and pulling direction and also, with tensile loading, adjusts the transmission and coupling means (67, 167), an adjustment of the transmission and coupling means (67, 167) disengaged by the respective other primary transmission means (131; 131b or 131a) leaving the associated catch decoupling means (155; 155b or 155a) in the starting position.
